(19) United States
(12) Patent Application Publication
(10) Pub. No.: US 2026/0081376 A1
(43) Pub. Date: Mar. 19, 2026

(54) OUTER CONDUCTOR OF CONNECTOR AND METHOD FOR FORMING OUTER CONDUCTOR OF CONNECTOR

(71) Applicant: JONHON OPTRONIC TECHNOLOGY CO., LTD., Luoyang (CN)

(72) Inventors: Penghui CHEN, Luoyang (CN); Wenjie ZHENG, Luoyang (CN); Qifan ZHANG, Luoyang (CN); Jianqiang HAN, Luoyang (CN); Hui GUO, Luoyang (CN)

(21) Appl. No.: 19/109,213

(22) PCT Filed: Feb. 13, 2023
(86) PCT No.: PCT/CN2023/075591

§ 371 Date: Mar. 6, 2025

(30) Foreign Application Priority Data
Sep. 22, 2022 (CN) 202211169241.X

(51) Int. Cl. H01R 13/02; H01R 13/6474; H01R 24/44; H01R 43/16

(52) U.S. Cl. CPC H01R 13/02; H01R 13/6474; H01R 24/44; H01R 43/16

(57) ABSTRACT

An outer conductor of the connector includes a stamped outer conductor matrix, and a variable-diameter structure with a reduced radial size at a front end of the outer conductor matrix; a folding part folded inward and with a backward tail end at the front end of the outer conductor matrix, and the folding part forms the variable-diameter structure; and the folding part includes process grooves penetrating the tail end of the folding part and used to adapt to a circle-holding stamping process to form a seam opening at a side of the outer conductor matrix. The folding part includes the process grooves penetrating forward, and a material of the folding part with a reduced distribution diameter can deform and expand into the process grooves, so the folding part of the outer conductor can form the seam opening at a side of the outer conductor through circle-holding stamping processing.

### TECHNICAL FIELD

The present invention relates to the technical field of connectors, and in particular to an outer conductor of a connector.

### BACKGROUND

A connector includes a plug and a socket. The plug and the socket are electrically connected in an insertion manner of a pin and a jack. In the known vehicle-mounted high-speed connector, particularly a connector of minifakra and vehicle-mounted Ethernet, a contact element forms a pin or a jack, an insulating element is sleeved at the periphery of the contact element, an outer conductor is sleeved at the periphery of the insulating element, a part of a front end of the insulating element corresponding to a docking interface of the pin and the jack has an outer diameter change, and the outer conductor is required to be subjected to variable-diameter treatment to match the outer diameter change of the insulating element, thereby reducing the characteristic impedance of the connector.

The structure of the outer conductor is the structure of the outer conductor disclosed in China patent application with the application publication number CN110277698A, as shown in FIG. 1, including an outer conductor matrix 200, where an end part of an interface side of the outer conductor matrix 200 is connected to an outer conductor ring 300, and in one embodiment, the outer conductor matrix 200 and the outer conductor ring 300 are integrally formed. The outer conductor ring 300 is reduced in diameter relative to the outer conductor matrix 200. An accommodating groove 12 extending front and back is formed in the outer conductor matrix 200, an overhanging contact lug 201 is arranged on a peripheral surface of a front end of the outer conductor matrix 200, a root part of the contact lug 201 is fixed on a rear bottom wall of the accommodating groove 12, and a contact point 204 of the contact lug 201 can be engaged with the inserted connector. A protruded protective collar 305 is arranged on the outer conductor ring 300 and at a front end of the contact lug 201, and used to protect the contact lug 201 from being affected by a mechanical force. The contact lugs 201 located on upper and lower side surfaces of the outer conductor matrix 200 are separated from the outer conductor ring 300, and the outer conductor matrix 200 and the outer conductor ring 300 are connected only through materials overhanging on left and right sides to form a material bridge connection.

The outer conductor ring 300 and the outer conductor matrix 200 in the outer conductor structure are connected in the material bridge connection manner, and the outer conductor ring 300 has a bent protective collar 305, so generally, the whole outer conductor is processed by oppositely stamping two halves of outer conductors in a left and right direction, resulting in the formation of a seam opening in each of upper and lower sides of the outer conductor ring. The front end of the outer conductor matrix 200 is subjected to an outward tension when the pin is docked with the jack. Since a part of the outer conductor matrix 200 connected to the outer conductor ring 300 is an overhanging arm, a front end of the overhanging arm is easy to bend outward when being subjected to an outward action force, so as to drive the outer conductor ring 300 to deform outward, resulting in the opening risk of the seam opening of the outer conductor ring 300. Furthermore, when the contact lug 201 is engaged with the inserted connector, the action force of the inserted connector on the contact lug 201 has both axial and radial components, which is prone to the deformation of the outer conductor matrix 200 connected to the contact lug 201 to drive the seam opening to open. To avoid the opening of the seam opening, it is also necessary to add a welding process at the seam opening, resulting in a complex process and high processing cost.

### SUMMARY

An objective of the present invention is to provide an outer conductor of a connector, so as to solve the technical problems in the prior art that the outer conductor has a complex process and high processing cost. An objective of the present invention is further to provide a method for forming an outer conductor of a connector, so as to solve the technical problems in the prior art that the method for forming the outer conductor is complex and high in processing cost.

To achieve the above objective, the outer conductor of the connector provided by the present invention adopts the following technical solution.

An outer conductor of a connector includes a stamped outer conductor matrix, where the outer conductor matrix has a sleeve body structure, a variable-diameter structure with a reduced radial size is arranged at a front end of the outer conductor matrix, the variable-diameter structure is used to be matched with an impedance of the connector, a folding part folded inward and with a backward tail end is arranged at the front end of the outer conductor matrix, the folding part forms the variable-diameter structure, and the folding part is provided with process grooves penetrating through a tail end of the folding part and used to adapt to a circle-holding stamping process to form a seam opening at a side of the outer conductor matrix.

The present invention has the beneficial effects: in the outer conductor of the connector provided by the present invention, the variable-diameter structure of the outer conductor matrix is formed by the folding part that is folded toward a radial inner side, the variable-diameter structure on the outer conductor matrix has two layers of materials, and the outer conductor has high structural strength while meeting the requirement of adjusting the characteristic impedance. The folding part is provided with the process grooves penetrating forward, and a material of the folding part with a reduced distribution diameter can deform and expand into the process grooves to avoid the accumulation of redundant materials, so the folding part of the outer conductor can form the seam opening at a side of the outer conductor through circle-holding stamping processing. The outer conductor with only one seam opening can bear a higher tension, so that the opening probability of the seam opening in the folding part and the cost are reduced, and the process is simplified.

As a further improvement, the cross section of the outer conductor matrix is of an oblong, and the process grooves are located at four corners of the oblong.

The present invention has the following beneficial effects: the deformation of the four corners of the outer conductor matrix formed by circle-holding stamping is significant, so this design is beneficial for the corners of the folding part to extend and deform in the process grooves, thereby avoiding tearing.

As a further improvement, an accommodating groove extending front and back is formed in a peripheral surface of the outer conductor matrix, a contact lug with an overhanging front end is arranged in the accommodating groove, and the accommodating groove is located between the adjacent process grooves.

The present invention has the beneficial effects: compared with the design of arranging the process grooves at the front end of the accommodating groove, this design can avoid the connection between the folding part and the outer conductor matrix due to that the accommodating groove with a large size penetrates through the tail end of the folding part, thereby improving the integrity and the structural strength of the outer conductor.

As a further improvement, the folding part has a turnup located between tail ends of the two adjacent process grooves, the accommodating groove extends onto the folding part and forms a forward notch formed at the front end of the folding part, and a front end of at least one contact lug is located in the notch.

The present invention has the beneficial effects: according to this design, the length of the contact lug can be increased and the elasticity of the front end of the control lug can be improved.

As a further improvement, a front end face of the folding part is located in front of a front end face of the contact lug in the notch, so as to protect the contact lug from being axially extruded.

The present invention has the beneficial effects: according to this design, the front end face of the folding part can guide the outer conductor to be inserted into the inserted connector when the outer conductor is docked with the inserted connector, so that a protruding part of the contact lug can be smoothly inserted into the inserted connector, thereby avoiding the phenomenon of frequency collapse due to a docking force in an axial direction of the outer conductor applied to the protruding part when the protruding part cannot enter the inserted connector.

As a further improvement, the turnup enables the tail end of the accommodating groove to form a blind end.

The present invention has the beneficial effects: according to this design, the turnup is continuously connected in a circumferential direction as much as possible to improve the overall strength of the turnup.

As a further improvement, the folding part further includes a turnup rounded corner with the arc-shaped cross section, and the turnup rounded corner is connected to a front end face of the outer conductor matrix and the turnup.

The present invention has the beneficial effects: according to this design, the turnup rounded corner with the arc-shaped cross section is more beneficial to guiding the outer conductor to be inserted into the inserted connector.

To achieve the above objective, the method for forming the outer conductor of the connector provided by the present invention adopts the following technical solution:
step 1: process grooves penetrating through a front end face are processed on a surface of a front end of a plate-shaped outer conductor matrix;
step 2: the front end of the plate-shaped outer conductor matrix is folded inward until a tail end extends backward, and a folding part is processed at the front end of the plate-shaped outer conductor matrix; and
step 3: circle-holding stamping is performed on the plate-shaped outer conductor matrix, an outer conductor matrix with a set structure is processed, and a seam opening is formed at a side of the outer conductor matrix.

The present invention has the beneficial effects: in the method for forming the outer conductor of the connector provided by the present invention, the variable-diameter structure of the outer conductor matrix is formed by the folding part that is folded toward a radial inner side, the variable-diameter structure on the outer conductor matrix has two layers of materials, and the outer conductor has high structural strength while meeting the requirement of adjusting the characteristic impedance. The folding part is provided with the process grooves penetrating forward, and during circle-holding stamping, a material of the folding part with a reduced distribution diameter can deform and expand into the process grooves to avoid the accumulation of redundant materials and form the seam opening at only one side of the outer conductor. The outer conductor with only one seam opening can bear a higher tension, so that the opening probability of the seam opening in the folding part and the cost are reduced, and the process is simplified.

As a further improvement, the cross section of the outer conductor matrix is of an oblong, and the process grooves are located at four corners of the oblong.

The present invention has the following beneficial effects: the deformation of the four corners of the outer conductor matrix formed by circle-holding stamping is significant, so this design is beneficial for the corners of the folding part to extend and deform in the process grooves, thereby avoiding tearing.

As a further improvement, an accommodating groove extending front and back is formed in a peripheral surface of the outer conductor matrix, a contact lug with an overhanging front end is arranged in the accommodating groove, and the accommodating groove is located between the adjacent process grooves.

The present invention has the beneficial effects: compared with the design of arranging the process grooves at the front end of the accommodating groove, this design can avoid the connection between the folding part and the outer conductor matrix due to that the accommodating groove with a large size penetrates through the tail end of the folding part, thereby improving the integrity and the structural strength of the outer conductor.

### BRIEF DESCRIPTION OF DRAWINGS

FIG. 1 is a structural schematic diagram of an outer conductor in the prior art;

FIG. 2 is a structural schematic diagram of a connector applicable to an outer conductor of a connector according to the present invention;

FIG. 3 is a structural schematic diagram of an outer conductor of a connector according to the present invention;

FIG. 4 is a sectional view of FIG. 3;

FIG. 5 is a longitudinal sectional view of FIG. 3;

FIG. 6 is an enlarged view of a part A in FIG. 5;

FIG. 7 is a transverse sectional view of FIG. 3; and

FIG. 8 is an enlarged view of a part B in FIG. 7.

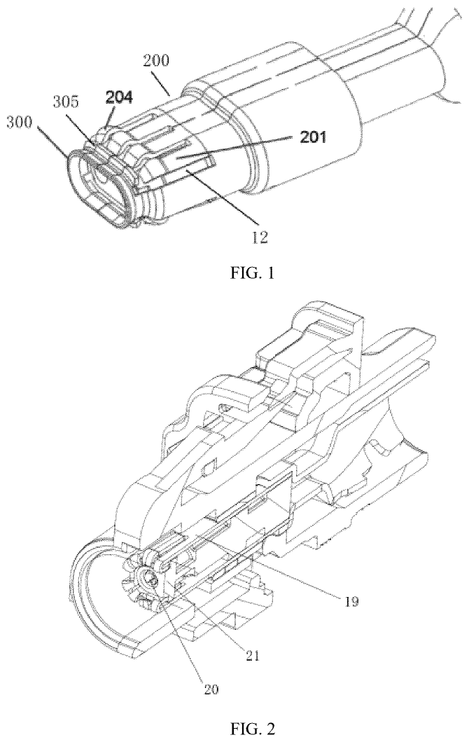

Description of reference numerals: 200. outer conductor matrix; 201. contact lug; 204. contact point; 300. outer conductor ring; 305. protective collar; 11. outer conductor matrix; 12. accommodating groove; 13. contact lug; 14. protruding part; 15. folding part; 16. turnup; 17. turnup rounded corner; 18. seam opening; 19. outer conductor; 20. contact element; 21. insulating element; 22. process groove; 23. notch.

### DETAILED DESCRIPTION OF THE EMBODIMENTS

To make the objectives, technical solutions and advantages of the present invention clearer, the present invention will be further described below in detail with reference to the accompanying drawings and embodiments. It should be understood that the described specific embodiments are merely used to explain the present invention, rather than to limit the present invention. That is, the described embodiments are only some rather than all of the embodiments. Generally, the components in the embodiments of the present invention described and shown in the figures herein can be arranged and designed in various configurations.

Therefore, the following detailed description of the examples of the present invention in the accompanying drawings is not intended to limit the protection scope of the present invention, but merely represent selected examples of the present invention. All other embodiments obtained by those skilled in the art based on the embodiments of the present invention without creative efforts shall fall within the protection scope of the present invention.

It should be noted that in the specific embodiments of the present invention, relational terms such as “first” and “second” are only used to differentiate one entity or operation from another entity or operation, and do not necessarily require or imply that actual relation or sequence exists between these entities or operations. Moreover, the possible terms such as “include” and “comprise” or any of their variants are intended to cover a non-exclusive inclusion, so that a process, method, article, or device that includes a list of elements not only includes those elements but also includes other elements that are not expressly listed, or further includes elements inherent to such process, method, article or device. Without more restrictions, the elements defined by the possible sentence “including a . . . ” do not exclude the existence of other identical elements in the process, method, article, or device including the elements.

In the description of the present invention, unless otherwise specified and limited, possible terms such as “mounting”, “connected” and “connection” should be understood broadly. For example, they may be fixed connection, detachable connection or integrated connection, may be mechanical connection or electrical connection, may be direct connection or indirect connection through an intermediate medium, or may be internal communication of two elements. Those skilled in the art may understand specific meanings of the foregoing terms in the present invention based on a specific situation.

In the description of the present invention, unless otherwise specified and limited, possible terms such as “provided” should be understood broadly. For example, the “provided” object may be a part of the body or may be arranged separately from the body and connected to the body. The connection may be detachable connection or non-detachable connection. Those skilled in the art may understand specific meanings of the foregoing terms in the present invention based on a specific situation.

The present invention is further described in detail below with reference to the embodiments.

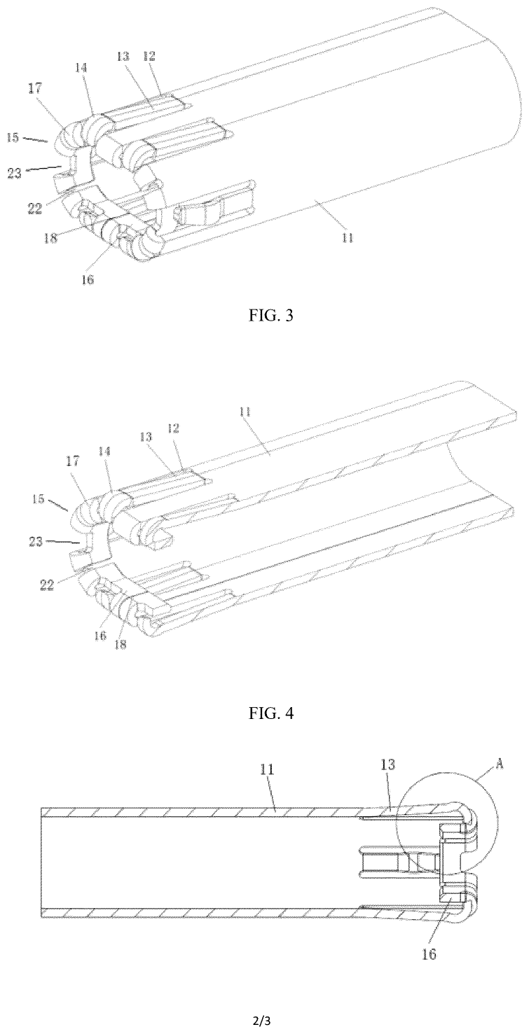

Embodiment 1 of an outer conductor of a connector provided by the present invention:
as shown in FIG. 2 and FIG. 3, the connector includes a contact element 20, the contact element 20 forms a jack or a pin, an insulating element 21 is sleeved at the periphery of the contact element 20, a docking interface area on the insulating element 21 corresponding to the jack and the pin has a necking opening, and an outer conductor 19 is sleeved at the periphery of the insulating element 21. The insertion direction of the outer conductor 19 is defined as the front of the outer conductor 19.

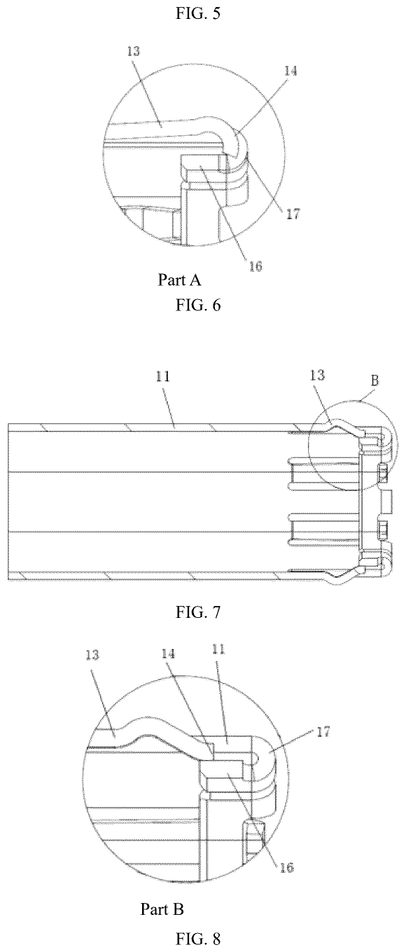

As shown in FIG. 4 to FIG. 8, the outer conductor 19 includes a hollow outer conductor matrix 11, the cross section of the outer conductor matrix 11 is of an oblong sleeve body structure, and a folding part 15 folded toward a radial inner side and with a backward tail end is arranged at the front end of the outer conductor matrix 11. The outer conductor 19 is processed by a circle-holding stamping process. To achieve the inward folding of the outer conductor matrix 11, the folding part 15 is provided with four process grooves 22 penetrating through the tail end of the folding part 15, and the four process grooves 22 are distributed at four corners of the outer conductor matrix 11, so that the material of the folding part 15 with the reduced distribution diameter in the circle-holding stamping process can deform to the process grooves 22 to avoid the accumulation of redundant materials.

The folding part 15 has a turnup rounded corner 17 and a turnup 16 located between the tail ends of the adjacent two process grooves 22, the cross section of the turnup rounded corner 17 is arc-shaped, and the turnup 16 and the front end face of the outer conductor matrix 11 are connected through the turnup rounded corner 17. The inner diameter of the turnup 16 is less than the inner diameter of the outer conductor matrix 11, and a variable-diameter structure is formed to be matched with the outer diameter change of the docking interface area of the pin and the jack on the insulating element 21 so as to reduce the characteristic impedance of the connector. In other embodiments, the turnup 16 and the front end face of the outer conductor matrix 11 are connected through right-angle transition.

An accommodating groove 12 extending front and back is formed at a front end of a peripheral surface of the outer conductor matrix 11, the accommodating groove 12 extends forward to the folding part 15 and forms a forward notch 23 at the front end of the folding part 15, and the turnup 16 enables the tail end of the accommodating groove 12 to form a blind end, so that the turnup 16 is connected continuously as much as possible in a circumferential direction. Six accommodating grooves 12 are provided, all the accommodating grooves 12 are distributed at intervals in the circumferential direction of the outer conductor matrix 11, and a part on the outer conductor matrix 11 between the two adjacent accommodating grooves 12 is connected to the folding part 15, so that the connection strength of the folding part 15 and the outer conductor matrix 11 is improved. Two accommodating grooves 12 are formed in each of upper and lower side surfaces of the outer conductor matrix 11, one accommodating groove 12 is formed in each of left and right sides of the outer conductor matrix 11, and the four process grooves 22 are respectively located between the accommodating grooves 12 on the upper, lower, left and right sides of the outer conductor matrix 11 and the adjacent accommodating grooves 12.

A contact lug 13 with an overhanging front end is arranged in each of the accommodating grooves 12, a root part of the contact lug 13 is fixed on a rear bottom wall of each of the accommodating grooves 12, the front end of the contact lug 13 has a protruding part 14 bending toward a radial inner side of the outer conductor matrix 11, and the protruding part 14 is located in the notch 23 at the front end of the folding part 15. A front end face of the turnup rounded corner 17 is located at a front end of a front end face of the protruding part 14. When the outer conductor 19 is docked with the inserted connector, the turnup rounded corner 17 can guide the outer conductor 19 to be inserted into the inserted connector, so that the contact lug 13 can be smoothly inserted into the inserted connector, thereby avoiding the phenomenon of frequency collapse due to an extruding force in an axial direction of the outer conductor 19 applied to the protruding part 14 when the contact lug 13 cannot enter the inserted connector.

The method for forming the outer conductor of the connector is described below, including the following steps:
Step 1: four process grooves 22 and six accommodating grooves 12 which are distributed at intervals are processed in a surface of a front end of a plate-shaped outer conductor matrix 11, where the process grooves 22 penetrate through the front end of the plate-shaped outer conductor matrix 11, and the accommodating grooves 12 have a certain distance from the front end of the outer conductor matrix 11. The four process grooves 22 are divided into two groups, each group includes two adjacent process grooves 22, two accommodating grooves 12 are distributed between each group of process grooves 22, and the remaining two accommodating grooves 12 are respectively distributed on two sides of one group of process grooves 22.
Step 2: the front end of the plate-shaped outer conductor matrix 11 is folded inward and the tail end of a folding part 15 extends backward, where the folding part 15 includes a turnup rounded corner 17 and a turnup 16 parallel to a surface of the plate-shaped outer conductor matrix 11, the cross section of the turnup rounded corner 17 is arc-shaped, and front groove walls of the folded accommodating grooves 12 are just located on a front end face of the turnup 16.
Step 3: the plate-shaped outer conductor matrix 11 is subjected to circle-holding stamping to form a sleeve body structure with an oblong cross section, a seam opening 18 is formed only in a lower side of the outer conductor matrix 11, and the four process grooves 22 are respectively located at four corners of the outer conductor matrix 11.

The folding part 15 is folded toward the radial inner side of the outer conductor matrix 11, and the outer conductor 19 has two layers of materials at the folding part 15, so the structural strength of the outer conductor 19 is high while the outer conductor 19 meets the function of adjusting the characteristic impedance. Since the folding part 15 is provided with the process grooves 22 penetrating forward, the material of the folding part 15 with the reduced distribution diameter can expand and deform in the process grooves 22 to avoid the accumulation of redundant materials. Therefore, the folding part 15 can perform circle-holding stamping and form the seam opening 18 only in one side of the outer conductor 19. The accommodating grooves 12 in the outer conductor matrix 11 are distributed at intervals in the circumferential direction, and the folding part 15 has a continuous material connected to the outer conductor matrix 11 in the circumferential direction, so that the folding part 15 and the outer conductor matrix 11 have good integrity, the connection strength between the folding part 15 and the outer conductor matrix 11 is high, the outer conductor matrix 11 can bear a high tension, the opening probability of the seam opening 18 on the folding part 15 and the cost are reduced, and the process is simplified.

Embodiment 2 of an outer conductor of a connector provided by the present invention:
This embodiment is different from Embodiment 1 in that: in Embodiment 1, the cross section of the outer conductor matrix 11 is of an oblong, and the process grooves 22 are located at four corners of the oblong; and in this embodiment, the process grooves 22 are located on left and right sides of the outer conductor matrix 11. In other embodiments, the cross section of the outer conductor matrix 11 may be of an oblong and a rounded corner rectangle. It should be noted that the number of the process grooves 22 can be changed according to the actual requirements and the shape of the outer conductor matrix 11.

Embodiment 3 of an outer conductor of a connector provided by the present invention:
This embodiment is different from Embodiment 1 in that: in Embodiment 1, the accommodating groove 12 extending front and back is formed in a peripheral surface of the outer conductor matrix 11, a contact lug 13 with an overhanging front end is arranged in the accommodating groove 12, and the accommodating groove 12 is located between the adjacent process grooves 22; and in this embodiment, the process grooves 22 are formed in the folding part 15 corresponding to the front and back of the accommodating groove 12, and the process grooves 22 penetrates through the tail end of the folding part 15 and communicates with the accommodating groove 12.

Embodiment 4 of an outer conductor of a connector provided by the present invention:
This embodiment is different from Embodiment 1 in that: in Embodiment 1, the folding part 15 has a turnup 16 located between the tail ends of the two adjacent process grooves 22, the accommodating groove 12 extends to the folding part and forms a forward notch 23 at the front end of the folding part, and the front ends of all the contact lugs 13 are located in the notch 23; and in this embodiment, some of the accommodating grooves 12 have a certain distance from the front end face of the outer conductor matrix 11 in the axial direction of the outer conductor matrix 11, so that the front end of the folding part is not provided with the notch 23. In other embodiments, all the accommodating grooves 12 can have a certain distance from the front end face of the outer conductor matrix 11 in the axial direction of the outer conductor matrix 11, that is, all the notches 23 at the front end of the folding part are canceled. In other embodiments, the accommodating grooves 12 also can extend and penetrate through the tail end of the folding part.

Embodiment 5 of an outer conductor of a connector provided by the present invention:
This embodiment is different from Embodiment 1 in that: in Embodiment 1, the front end face of the folding part is located in front of the front end face of the contact lug 13 in the notch 23 and used to protect the contact lug 13 from being axially extruded; and in this embodiment, the front end face of the protruding part 14 has a certain distance from the front end face of the folding part 15, and a protective collar extending in the circumferential direction of the outer conductor matrix 11 is arranged on the peripheral surface of the outer conductor matrix 11 at the front end of the accommodating groove 12.

Embodiment 1 of the method for forming the outer conductor of the connector according to the present invention:
the method for forming the outer conductor of the connector in this embodiment is the same as the method for forming the outer conductor of the connector in Embodiment 1, which will not be described in detail here.

Embodiment 2 of the method for forming the outer conductor of the connector according to the present invention:
this embodiment is different from Embodiment 1 in that: in Embodiment 1, the cross section of the outer conductor matrix 11 with the set structure is of an oblong, and the process grooves 22 are located at four corners of the oblong; and in this embodiment, the process grooves 22 are located on left and right sides of the outer conductor matrix 11. In other embodiments, the cross section of the outer conductor matrix 11 may be of an oblong and a rounded corner rectangle. It should be noted that the number of the process grooves 22 can be changed according to the actual requirements and the shape of the outer conductor matrix 11.

Embodiment 3 of the method for forming the outer conductor of the connector according to the present invention:
this embodiment is different from Embodiment 1 in that: in Embodiment 1, the accommodating groove 12 is located between the adjacent process grooves 22; and in this embodiment, the process grooves 22 correspond to the front and back of the accommodating groove 12, the front ends of the process grooves 22 forward penetrate through the front end of the plate-shaped outer conductor matrix 11, and the rear ends of the process grooves 22 communicate with the accommodating groove 12.

The above are only the preferred embodiments of the present invention and are not intended to limit the present invention. The patent protection scope of the present invention is subject to the claims. All equivalent structural changes made by using the contents of the specification and the drawings of the present invention should similarly be included in the protection scope of the present invention.

1. An outer conductor of a connector, comprising a stamped outer conductor matrix, wherein the outer conductor matrix has a sleeve body structure, a variable-diameter structure with a reduced radial size is arranged at a front end of the outer conductor matrix, the variable-diameter structure is used to be matched with an impedance of the connector, a folding part folded inward and with a backward tail end is arranged at the front end of the outer conductor matrix, the folding part forms the variable-diameter structure, and the folding part is provided with process grooves penetrating through a tail end of the folding part and used to adapt to a circle-holding stamping process to form a seam opening at a side of the outer conductor matrix.

2. The outer conductor of a connector according to claim 1, wherein the cross section of the outer conductor matrix is of an oblong, and the process grooves are located at four corners of the oblong.

3. The outer conductor of a connector according to claim 1, wherein an accommodating groove extending front and back is formed in a peripheral surface of the outer conductor matrix, a contact lug with an overhanging front end is arranged in the accommodating groove, and the accommodating groove is located between the adjacent process grooves.

4. The outer conductor of a connector according to claim 3, wherein the folding part has a turnup located between tail ends of the two adjacent process grooves, the accommodating groove extends onto the folding part and forms a forward notch formed at the front end of the folding part, and a front end of at least one contact lug is located in the notch.

5. The outer conductor of a connector according to claim 4, wherein a front end face of the folding part is located in front of a front end face of the contact lug in the notch, so as to protect the contact lug from being axially extruded.

6. The outer conductor of a connector according to claim 4, wherein the turnup enables a tail end of the accommodating groove to form a blind end.

7. The outer conductor of a connector according to claim 4, wherein the folding part further has a turnup rounded corner with the arc-shaped cross section, and the turnup rounded corner is connected to a front end face of the outer conductor matrix and the turnup.

8. A method for forming an outer conductor of a connector, comprising the following steps:
step 1: processing process grooves penetrating through a front end face on a surface of a front end of a plate-shaped outer conductor matrix;
step 2: folding the front end of the plate-shaped outer conductor matrix inward until a tail end extends backward, and processing a folding part at the front end of the plate-shaped outer conductor matrix; and
step 3: performing circle-holding stamping on the plate-shaped outer conductor matrix, processing an outer conductor matrix with a set structure, and a seam opening is formed at a side of the outer conductor matrix.

9. The method for forming an outer conductor of a connector according to claim 8, wherein the cross section of the outer conductor matrix with the set structure is of an oblong, and the process grooves are located at four corners of the oblong.

10. The method for forming an outer conductor of a connector according to claim 8, wherein in the step 1, an accommodating groove extending front and back is further processed in the plate-shaped outer conductor matrix, a contact lug with an overhanging front end is arranged in the accommodating groove, and the accommodating groove is located between the adjacent process grooves.
